(19) United States
(12) Patent Application Publication
(10) Pub. No.: US 2007/0252033 A1
(43) Pub. Date: Nov. 1, 2007

(54) Discoidal flying craft

(76) Inventor: Dumitru Bojiuc, Dana Point, CA (US)

Correspondence Address: PATENT LAW & VENTURE GROUP, 2424 S.E. BRISTOL, SUITE 300, NEWPORT BEACH, CA, 92660, US

(21) Appl. No.: 11/210,035

(22) Filed: Aug. 22, 2005

Related U.S. Application Data
(60) Provisional application No. 60/603,444, filed on Aug. 20, 2004.

(51) Int. Cl. B64C 39/00

(52) U.S. Cl. 244/62

(57) ABSTRACT

A flying discoidal rotorcraft is equipped with a double counter rotated pulsed DC electric linear-toroidal electric motor-generator combined with a magnetically levitated suspension of the rotorcraft body over the propulsion assembly. The inner and outer rims are made up of electro-active-magnetic levitation and guidance pilot solenoids as the fixed portion of the stator's assembly and electrokinetic motor-generator and also the attached part of the craft's body. The mobile portion is double independent counter rotated ferromagnetic cores, wherein rotors of the electrokinetic motor-generator have three main components: electromagnets or solenoids including in their functions external and internal electromagnetic and guidance solenoids and energy collector and inductor; electric motor-generator solenoid coils; and a ring propeller.

### RELATED APPLICATIONS

This application claims international priority from a prior filed U.S. Provisional Patent Application having serial number U.S. 60/603,444 filed with the United States Patent Office on Aug. 20, 2004 and which is copending with this present non-provisional application. U.S. 60/603,444 is hereby incorporated herein by reference. This application is a Continuation-In-Part application of a prior filed U.S. patent application having Ser. No. 11/200,920 and entitled “Monopole Field Electric Motor Generator” filed on Aug. 9, 2005.

### BACKGROUND

1. Field of the Present Disclosure

This disclosure relates generally to electric motor-generators and more particularly to a DC rotating electromagnetic machine operating by induction as a flying craft.

2. Description of Related Art

The following art defines the present state of the field of the apparatus described and claimed herein:

Tu et al, US 2004/0135452, discloses a flat rotary electric generator that includes at least one toroidal coil structure for cutting magnetic lines to induce a current and at least one disc-shaped magnetic pole structure oriented parallel to the helical coil structure. If multiple toroidal coil structures and disc-shaped magnetic coil structures are included, the toroidal coil structures and disc-shaped magnetic coil structures are arranged in alternating manner. The toroidal coil structure and disc-shaped magnetic pole structure are not provided with a permeable material. When either the toroidal coil structures or the at least one disc-shaped magnetic pole structure is rotated by an external force, the toroidal coil structure cuts the magnetic lines passing therethrough to generate an induced current. Neal, US 2002/0135263, discloses a plurality of stator arc segments that form a toroidal core for a stator assembly used to make a motor. In a preferred embodiment, a plurality of magnetic fields is created when electrical current is conducted through wire wound around poles on the toroidal core. A monolithic body of phase change material substantially encapsulates the conductors and holds the stator arc segments in contact with each other in the toroidal core. Hard disc drives using the motor, and methods of constructing the motor and hard disc drives are also disclosed. Rose, U.S. Pat. No. 6,803,691, discloses an electrical machine that comprises a magnetically permeable ring-shaped core centered on an axis of rotation and having two axially-opposite sides. Coils are wound toroidally about the core and disposed sequentially along the circumferential direction. Each coil includes two side legs extending radially alongside respectively sides of the core. Coil-free spaces exist between adjacent side legs. A bracket has first and second side flanges that are connected by a bridging structure and respectively abut the first and second sides of the coil. Mohler, U.S. Pat. No. 6,507,257, discloses a bi-directional latching actuator that is comprised of an output shaft with one or more rotors fixedly mounted thereon. The shaft and rotor are mounted for rotation in a magnetically conductive housing having a cylindrical coil mounted therein and is closed by conductive end caps. The end caps have stator pole pieces mounted thereon. In one embodiment, the rotor has at least two oppositely magnetized permanent magnets which are asymmetrically mounted, i.e., they are adjacent at one side and separated by a non-magnetic void on the other side. The stator pole piece has asymmetric flux conductivity and in one embodiment is axially thicker than the remaining portion of the pole piece. An abutment prevents the rotor from swinging to the neutral position (where the rotor magnets are axially aligned with the higher conductivity portion of the pole piece). Thus, the rotor is magnetically latched in one of two positions being drawn towards the neutral position. Energization of the coil with an opposite polarity current causes the rotor to rotate towards its opposite latching position whereupon it is magnetically latched in that position. Mohler, U.S. Pat. No. 5,337,030, discloses a permanent magnet brushless torque actuator that is comprised of an electromagnetic core capable of generating an elongated toroidally shaped magnet flux field when energized. Outside the generally cylindrical coil is an outer housing with upper and lower end plates at each end. Mounted to the end plates and extending towards each other are stator pole pieces separated from its opposing pole piece by an air gap. A permanent magnet rotor is disposed in the air gap and mounted on a shaft which in turn is rotatably mounted in each of the end plates. The permanent magnet rotor comprises at least two permanent magnets, each covering an arcuate portion of the rotor and having opposite polarities. Energization of the coil with current in one direction magnetizes the pole pieces such that each of the two pole pieces attracts one of the magnets of the rotor and repels the other magnet of the rotor resulting in a torque generated by the output shaft. Reversal of the current flow results in a reversal of the torque and rotation of the rotor in the opposite direction. Preferred embodiments are disclosed having multiple cells, i.e. a plurality of stator rotor stator combinations and/or cells in which there are a plurality of pole pieces at each stator pole plane. Kloosterhouse et al, U.S. Pat. No. 5,191,255, discloses an electromagnetic motor that includes a rotor having a plurality of magnets mounted along a perimeter of the rotor. Preferably, adjacent magnets have opposite poles facing outward. One or more electromagnets are disposed adjacent to the perimeter of the rotor so that as the rotor rotates, the magnets mounted on the rotor are carried near the poles of the electromagnets. Current is supplied to the electromagnets by a drive circuit in a predetermined phase relationship with the rotation of the rotor such that, for substantially all angular positions of the rotor, magnetic attraction and repulsion between the poles of the electromagnets and the magnets mounted on the rotor urge the rotor to rotate in a desired direction. Reflective material is mounted on the rotor in predetermined angular positions. The drive circuit includes a photosensitive device which produces a signal whose value varies according to whether the device is receiving light reflected from the reflective material. The signal is amplified to produce drive current for the electromagnets. Westley, U.S. Pat. No. 4,623,809, discloses a stepper motor housing a pole structure in which a pair of identical stator plates, each having a plurality of poles, are positioned back to back with the poles projecting in opposite directions, the stator plates being positioned between a pair of substantially identical stator cups, each stator cup having a plurality of poles projecting inwardly from a back wall with a peripheral side wall terminating in an outwardly extending flange. A major surface of each flange is in contact with a face on one of the stator plates so as to assure a low reluctance magnetic path. Fawzy, U.S. Pat. No. 4,565,938, discloses an electromechanical device which can be used as a motor or as a generator. The device has a housing, including bearing means to support a rotatable shaft. Disc magnet means are provided, and poled to have alternating polarity and are mounted on the shaft to define a rotor. The device includes at least one first pole shoe in contact with the magnet means, having a portion extending radially therefrom to define a virtual pole chamber, of a first polarity. Also included is at least one second pole shoe in contact with the magnet and having a portion extending radially therefrom to define a virtual pole chamber of the other polarity. A toroid stator is mounted on the housing and has windings thereon. The stator is positioned annularly around the disc magnets such that the virtual pole chambers of the first and second pole shoes surround portions of said windings with circumferentially alternating fields of alternating polarity. Means are provided for electrical contact with the stator to draw off current when the device is operated as a generator, or provide current to operate the device as a motor. Fawzy, U.S. Pat. No. 4,459,501, discloses an electromechanical device which can be used as a motor or as a generator that has a housing, including bearing means to support a rotatable shaft. A pair of disc magnets are poled to have opposite polarity on the two faces of each. The magnets are mounted face to face together on the shaft to define a rotor. The device includes at least one first pole shoe in contact with one face of each magnet, and having a portion extending radially therefrom to define, in its preferred form, a pair of virtual pole chambers, of the same polarity as said one face. Also included is at least one second pole shoe in contact with the other face of each magnet and having a portion extending radially therefrom to define in its preferred form a pair of virtual pole chambers of the same polarity as the other face. A toroidal stator is mounted on the housing and has windings thereon. The stator is positioned annularly around the disc magnets such that the virtual pole chambers of the first and second pole shoes surround portions of said windings with circumferentially alternating fields of alternating polarity. Means for electrical contact with the stator draw off current when the device is operated as a generator, or provide current to operate the device as a motor.

Our prior art search with abstracts described above teaches rotating electromagnet machines; in both motor and generator forms. Thus, the prior art shows in Neal, a toroidal core with radial arc segments, in Fawzy, we see a N-N and S-S pole face adjacency, in Tu et al, a N-S and S-N pole adjacency with radial coil windings, in Rose, we find radially wound coils in sequence around a toroidal core and with permanent magnet segments with N-N and S-S adjacency. However, the prior art fails to teach a rotating electromagnetic machine that provides electromagnetic fields immersed in monopole permanent magnet fields of opposite polarities as is shown in the present apparatus and which provides operation by induction.

The present disclosure distinguishes over the prior art providing heretofore unknown advantages as described in the following summary.

### SUMMARY

This disclosure teaches certain benefits in construction and use which give rise to the objectives described below.

A flying discoidal rotorcraft is equipped with a double counter rotated pulsed DC electric linear-toroidal electric motor-generator combined with a magnetically levitated suspension of the rotorcraft body over the propulsion assembly. The inner and outer rims are made up of electro-active-magnetic levitation & guidance pilot solenoids as the fixed portion of the stator's assembly and electrokinetic motor-generator and also the attached part of the craft's body. The mobile portion is double independent counter rotated ferromagnetic cores, wherein rotors of the electrokinetic motor-generator have three main components: electromagnets or solenoids including in their functions external and internal electromagnetic & guidance solenoids and energy collector and inductor; electric motor-generator solenoid coils; and a ring propeller.

A primary objective inherent in the above described apparatus and method of use is to provide advantages not taught by the prior art.

Another objective is to provide an electromagnetic rotating machine which develops a levitating force and a propulsion force.

A further objective is to provide such a machine capable of movement within the atmosphere.

A further objective is to provide such a machine capable of movement outside of the atmosphere.

Other features and advantages of the described apparatus and method of use will become apparent from the following more detailed description, taken in conjunction with the accompanying drawings, which illustrate, by way of example, the principles of the presently described apparatus and method of its use.

### BRIEF DESCRIPTION OF THE DRAWINGS

The accompanying drawings illustrate at least one of the best mode embodiments of the present apparatus and method of it use. In such drawings:

FIG. 1 is a top plan view of the presently described apparatus;

FIG. 2 is a further top plan view thereof showing a linear-toroidal ferromagnetic core thereof;

FIG. 3 is a schematic diagram showing a cross-section of a portion of the apparatus taken along line 3-3 in FIG. 2; and

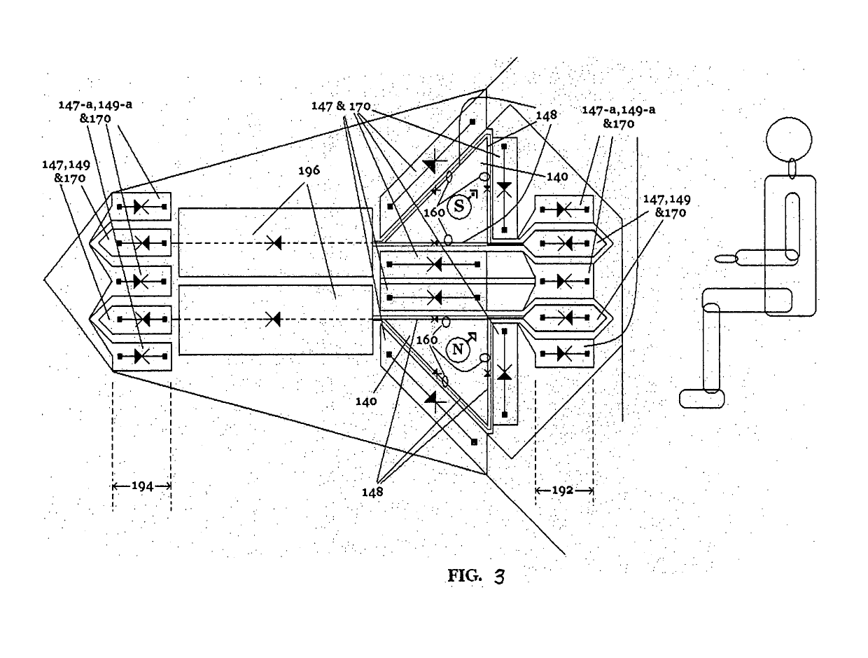

FIG. 4 is similar to FIG. 3 and further showing blade positions.

### LIST OF DRAWING NUMERALS

140 linear-toroidal ferromagnetic core
141 linear ferromagnetic core
142 the stator assembly;
144 shaft
146 permanent magnet
147 electromagnet or solenoid
147-a electro-active-magnetic solenoid
148 the electric motor-generator solenoid's coil;
149 electromagnetic levitation & guidance solenoid
149-a electro-active-magnetic levitation & guidance pilot solenoid
150 the stator housing Al support on shaft
152 the stator's housing external Al ring support
153 the internal stator's permanent magnet Al support
154 the stator's permanent magnet ferromagnetic material support
156 the ferromagnetic core's Al support on shaft
158 commutator
160 cylindrical gaps
162 window or the cylindrical gap's aperture;
164 laminated ferromagnetic core
166 the solenoid's linear area or portion
168 UMD N or S symbol and its magnetic field influence
176 energy collector & inductor
172 pad
174 bearing
176 arched polygonal brush
178 the cylindrical commutator's split ring
179 the discoidal commutator's split ring
180 the tronconic commutator's slip ring
181 the cylindrical slip ring
182 the commutator's dielectric material
183 metallic collecting ring
184 the commutator's contactors
186 spring
188 the brushes support
190 the cockpit or load support & auto balance assembly
192 the inner stator's electro-active-magnetic rim
194 the external stator's electro-active-magnetic rim
196 the double ring counter rotated propeller

### DETAILED DESCRIPTION

The above described drawing figures illustrate the described apparatus and its method of use in at least one of its preferred, best mode embodiments, which is further defined in detail in the following description. Those having ordinary skill in the art may be able to make alterations and modifications to what is described herein without departing from its spirit and scope. Therefore, it must be understood that what is illustrated is set forth only for the purposes of example and that it should not be taken as a limitation in the scope of the present apparatus and method of use.

The present apparatus is a double counter rotated linear-toroidal electrokinetic motor-generator capable of developing high rotational force, as a result of an energetic transformational process including an electrokinetic linear translational force effect.

As part of its physical mass in a controllable balanced-unbalanced rotational status, each of this electrokinetic motor-generator's counter rotated ferromagnetic core has a perfect symmetrical opposite direction and unbalanced amplitude with its counterpart, finally resulting in a joint asymmetric mass distribution, moving in fact the all system linearly in the direction of the main lever arm or mass furthest from the center axis of rotation.

This discoidal embodiment of the parent application is in fact a sealed linear electric motor-generator, which uses in its energetic transformational process the effects of interactions between the UMP-s of two different active magnetic sources.

This linear-toroidal electric motor-generator is doubled on a single shaft with each having an independent counter rotating liberty; thus “the double counter rotated linear-toroidal electrokinetic motor-generator”.

One of its important features is its shape; an external ring shaped rotor and stator assembly with a shaft represented by a flying craft's empennage or body, having a magnetically levitated bearing (no contact) guidance system.

Preferably the instant apparatus has the general shape of a double saucer with one overlapping a discoidal further one; a main double electrokinetic engine having an external ring shape located at the edge of body; a propulsion system being a combination between the air force levitation and an electrokinetic advancement force; and the drive fore is electromagnetic energy;

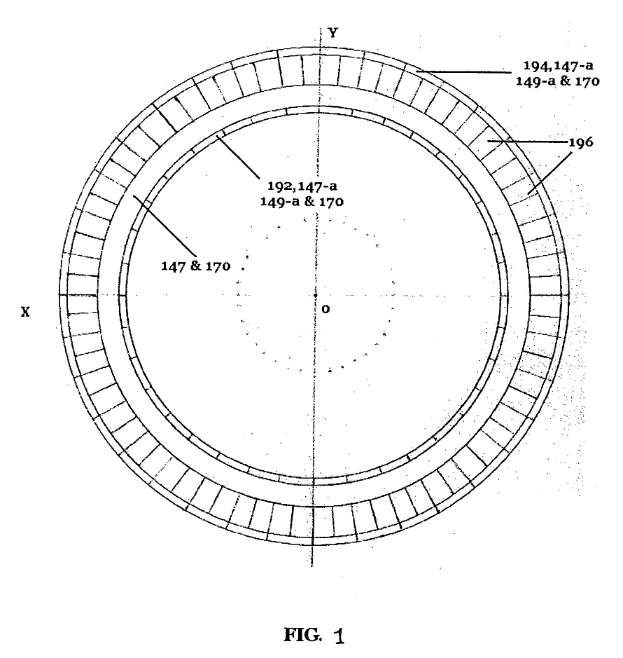

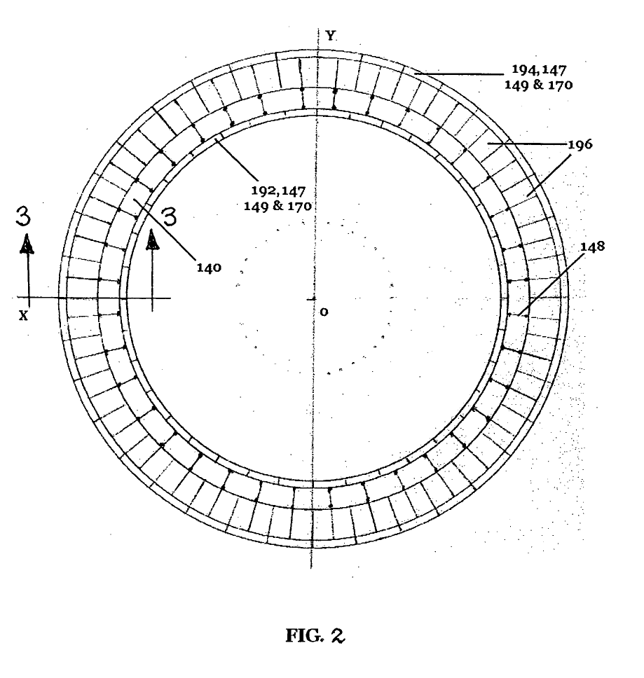

FIG. 1 is a general schematic perspective upper view of a flying discoidal rotorcraft equipped with a double counter rotated PDC linear-toroidal electric motor-generator combined with a magnetically levitated suspension of the rotorcraft body over the propulsion assembly. By this schematic upper point of view we can see the inner and outer rims 192 & 194 made up by electro-active-magnetic levitation & guidance pilot solenoids 149-a as the fixed portion of the stator's assembly and electrokinetic motor-generator and also the attached part of the craft's body. The mobile portion is the double independent counter rotated ferromagnetic cores, as seen in FIG. 2, showing the rotors of the electrokinetic motor-generator each having three main components: an electromagnets or solenoids 147 including in their functions the external and internal electromagnetic & guidance solenoids 149 and the energy collector & inductor 170; the electric motor-generator solenoid's coil 148; and the ring propeller 196.

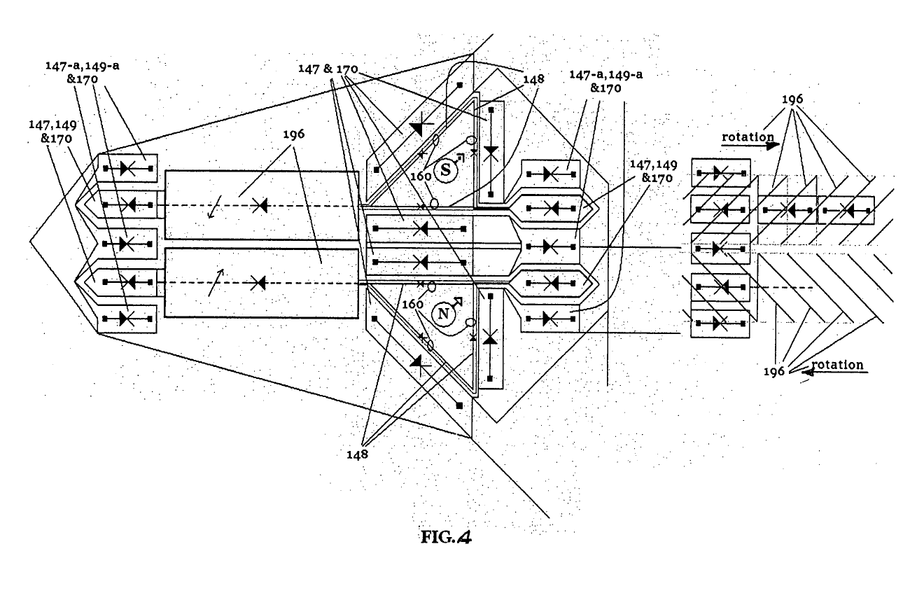

FIG. 4 is a schematic front left lateral cross-sectional view of the flying discoidal rotorcraft, showing the stator assembly and its double counter rotated PDC linear-toroidal electric motor-generator with its MAGLEV SYSTEM SUSPENSION. This magnetic levitated system combined with the electric energy feeding system by inducing it in the electromagnetic levitation & guidance solenoids 149 and then transferred through the energy collector & inductor's 170 function in the electric motor-generator solenoid's coil 148, is similar to my magnetically levitated transport system.

However, with the ends sealed, giving it the toroidal rotor's large external circumference's final shape, the double ferromagnetic cores high rotation inertia's energy are coming to give a very economically high thrust, a permanent controllable rotor's counterbalanced stability and its ability to add a high electrokinetic linear translational thrust to the entire body attached to it, when the two ferromagnetic core's counter rotation mass distributions are symmetrically unbalanced.

To obtain this effect we have to exploit the simultaneity and independency of each solenoid's effect as part of the entire system by transforming the electromagnetic impulses and hence obtaining the necessary controllable motor and generator effects in every single point of its embodiment.

Even together as part of the same embodiment, the two ferromagnetic rotated cores act independently transforming and then transferring the resulted effects toward their virtual new rotational axis of which common thrust and direction can be easy and simply determined.

We levitate the entire double counter rotated ferromagnetic core by generating through the electro-active-magnetic levitation & guidance pilot solenoid 149-a located in the upper and lower inner and external stator's electro-active-magnetic rims 192 & 194 a certain value and frequency of PDC (pulsing direct current) in each rotor's electromagnetic levitation & guidance solenoid 149 as shown in FIG. 4.

Each rotor's solenoid 149 is between the inner rim's of the 149-a solenoids which are connected in series with its diagonal correspondent 149 under the same 149-a external rim's solenoids and then connected in parallel with the same correspondingly alignment electric motor-generator solenoid's coil 148.

Each inner 192 and external 194 rim's 149-a solenoid, will generate a likewise UMD polarity in its under direct influenced ferromagnetic core's solenoids 147 & 149.

As effect of the induced electromagnetic force in each rotor's solenoid 149, a repealing counter electromagnetic energy's force will levitate and stabilize the entire ferromagnetic core and meantime the solenoid's coils 149 as effect of the UMP counter reactions against the 149-a solenoids impulses, will determine an electric current flux which will feed each of its alignment corresponding parallel connected 148 coils.

And now after the 148 solenoids coils are fed with the electric energy, pulsating as I've compared with the human body's blood pressure, the stator's “electromagnet or solenoid 147” & “energy collector & inductor 170” being fed with a PDC electric energy, their magnetic energetic effect will determine a foreseeable both ferromagnetic core's counter rotation.

The thrust and the speed will depend on the input's electro energetic value and frequency. From now the vertical and horizontal entire craft's back and forth, left and right or any of these sum of advancement commands are given, is a matter of electronic engineering.

Depending of what complexity will be adopted for this constructive variant, the vertical level sustaining effect and its up and down movement is ensured by the fixed or mobile angle propellants 196, as part of each counter rotated ferromagnetic core or their rotational speed.

For a simple rotor craft variant I've envisioned the already established propellants fixed angle which is good enough and sufficient for an average maneuver complexity. For a complex quick set-down or ascension maneuver combined with any back and forth advancement I've envisioned a variable propellant's angle of 196.

After the two counter rotated ferromagnetic cores are levitated and their rotations are sufficiently maintained in a stable balanced thrust, the craft's advancement will be obtained by unbalancing each ferromagnetic core's rotation or as it's said breaking the counter rotated ferromagnetic cores symmetries and hence resulting a new mass distribution given by the vectors kinetic forces.

To break the symmetry under rotation, we have to insert, by replacing, some of solenoid's 149-a functions. Instead of inducing electromagnetic impulses, we will accumulate energy by receiving the induced electromagnetic impulses from each “electric motor-generator solenoid's coil 148” as having the induced electric energy from the solenoid 147 & 170. Then the amount of DC electric energy will be induced through the 149 & 170 solenoids back into 149-a & 170 solenoids which beside the fact that it's continuing to levitate the under transited solenoids, will have the sufficient energy to compensate the breaking-down ferromagnetic core's rotation of this hemisphere, by infusing the accumulated electric energy into the next rotors hemisphere's 147-a & 149 solenoids.

The external ring is a perfect shield for any lateral collision, giving it the last chance to escape or survive. The advantage of floating and diving in water or to overcome extreme situations are some of its many possibilities.

Using this double rotated device as a self flying equipment fed by a wireless external generator in an adapted scale dimension, any human being can be saved or do a useful work in its outer space evolution being more than ever prepared to defend himself by anything jeopardizing its existence.

A system built up to defend our planet in an emergency aroused from outer space which can endanger even our civilization's existence would be more than sufficient to protect our future.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. A flying discoidal rotorcraft is equipped with a double counter rotated pulsed DC electric linear-toroidal electric motor-generator combined with a magnetically levitated suspension of the rotorcraft body over the propulsion assembly. The inner and outer rims are made up of electro-active-magnetic levitation & guidance pilot solenoids as the fixed portion of the stator's assembly and electrokinetic motor-generator and also the attached part of the craft's body. The mobile portion is double independent counter rotated ferromagnetic cores, wherein rotors of the electrokinetic motor-generator have three main components: electromagnets or solenoids including in their functions external and internal electromagnetic & guidance solenoids and energy collector and inductor; electric motor-generator solenoid coils; and a ring propeller.
